(19) United States
(12) Patent Application Publication
(10) Pub. No.: US 2026/0235853 A1
(43) Pub. Date: Aug. 13, 2026

(54) CAMERA MODULE

(71) Applicant: Samsung Electro-Mechanics Co., Ltd., Suwon-si (KR)

(72) Inventors: Jae Sung OH, Suwon-si (KR); Yun Gu LEE, Suwon-si (KR)

(73) Assignee: Samsung Electro-Mechanics Co., Ltd., Suwon-si (KR)

(21) Appl. No.: 19/259,818

(22) Filed: Jul. 3, 2025

(30) Foreign Application Priority Data
Feb. 12, 2025 (KR) 10-2025-0018280

(51) Int. Cl. G02B 13/00; G02B 7/04; G02B 7/18; G02B 7/20; H04N 23/55

(52) U.S. Cl. CPC G02B 13/0065; G02B 7/04; G02B 7/1805; G02B 7/20; H04N 23/55

(57) ABSTRACT

A camera module includes a prism module including a prism configured to reflect light incident along a first optical axis in a second optical axis direction and a prism holder configured to support the prism, and a lens module configured to focus light emitted from the prism onto an image sensor. In the camera module, a first space and a second space having different sizes are disposed between an edge of the prism and an inner surface of the prism holder.

### CROSS-REFERENCE TO RELATED APPLICATIONS

This application claims the benefit under 35 USC 119(a) of Korean Patent Application No. 10-2025-0018280 filed on February 12, 2025, in the Korean Intellectual Property Office, the entire disclosure of which is incorporated herein by reference for all purposes.

### BACKGROUND

### 1. Field

The present disclosure relates to a camera module including a prism.

### 2. Description of the Background

Portable electronic devices include camera modules. For example, portable phones, laptops, and the like commonly include one or more camera modules. Camera modules mounted on portable electronic devices have difficulty securing sufficient TTL (distance from a front lens to an imaging plane or an image sensor) due to spatial constraints of a portable electronic device. For this reason, a telephoto camera module includes a prism to secure sufficient TTL. However, since portable electronic devices (especially thin portable electronic devices) have narrow internal spaces, the prism of the camera module may be easily damaged by collision with other parts of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a prism module including a prism configured to reflect light incident along a first optical axis in a second optical axis direction and a prism holder configured to support the prism, and a lens module configured to focus light emitted from the prism onto an image sensor, wherein a first space and a second space having different sizes are disposed between an edge of the prism and an inner side-surface of the prism holder.

The camera module may further include a first driving unit configured to drive the prism holder.

The camera module may further include a second driving unit configured to drive the lens module.

A distance from the first space to an optical axis of the prism may be less than a distance from the second space to the optical axis of the prism.

The camera module may further include a buffer member disposed on the prism holder and protruding in the first optical axis direction.

The prism holder may include a first movable body configured to accommodate the prism, a second movable body configured to be coupled with the first movable body, and a ball bearing disposed between the first movable body and the second movable body to enable rotational movement of the first movable body with respect to the second movable body.

The camera module may further include a clip member coupled with the second movable body and configured to prevent the first movable body from being separated from the second movable body.

The camera module may further include a first driving unit configured to provide driving force for driving the first movable body.

The camera module may further include a first driving unit configured to rotate the second movable body around the first optical axis.

In another general aspect, a camera module includes a prism and a prism holder configured to support the prism, wherein the prism holder includes a recess portion configured to accommodate a portion of an adhesive member disposed between a side surface of the prism and the prism holder.

The recess portion may be disposed at a portion facing a corner of an incident surface of the prism.

The camera module may further include a first driving unit configured to drive the prism holder.

The camera module may further include a buffer member disposed on the prism holder and protruded in one direction.

The prism holder may include a first movable body configured to accommodate the prism, a second movable body configured to be coupled with the first movable body, and a ball bearing disposed between the first movable body and the second movable body to enable rotational movement of the first movable body with respect to the second movable body.

The camera module may further include a plurality of driving units configured to drive the first movable body and the second movable body in different directions.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIGS. 2 and 3 are partially exploded perspective views of the camera module illustrated in FIG. 1.

FIG. 4 is a partially exploded perspective view of a prism module and a housing illustrated in FIG. 2.

FIG. 5 is an exploded perspective view of the prism module illustrated in FIG. 4.

FIG. 6 is a plan view of the prism module illustrated in FIG. 5.

FIG. 7 is a partially exploded perspective view of a lens module and a housing illustrated in FIG. 3.

FIG. 8 is a perspective view of a camera module according to another embodiment of the present disclosure.

FIGS. 9 and 10 are partially exploded perspective views of the camera module illustrated in FIG. 8.

FIG. 11 is a partially exploded perspective view of a prism module and a housing illustrated in FIG. 10.

FIG. 12 is an exploded perspective view of the prism module illustrated in FIG. 11.

FIG. 13 is a plan view of the prism module illustrated in FIG. 12.

FIG. 14 is a partially exploded perspective view of a lens module and a housing illustrated in FIG. 10.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The camera module according to an embodiment of the present disclosure may be mounted on an electronic device. For example, the camera module may be mounted on a portable terminal, laptop, VR device, glasses, or the like. However, electronic devices on which a camera module may be mounted are not limited to the devices described above. As an example, the camera module may be mounted on any portable electronic device, such as a portable game console.

An aspect of the present disclosure is to provide a camera module configured to reduce a performance degradation phenomenon of the camera module due to breakage of prism.

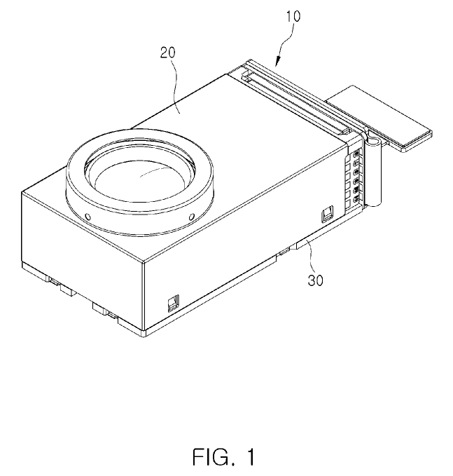

First, a camera module according to an embodiment will be described with reference to FIGS. 1 to 7.

A camera module 10 according to the present embodiment may include a case 20 and a housing 30 as illustrated in FIGS. 1 to 3. However, the configuration of the camera module 10 is not limited to the case 20 and the housing 30.

The case 20 may be configured to protect main components of the camera module 10. For example, the case 20 may be configured as a form surrounding the housing 30 so that an open portion and a significant portion of the housing 30 are not exposed to outside. The case 20 may be configured to shield electromagnetic waves. For example, the case 20 may be formed of a material blocking or shielding the electromagnetic waves so that main components of the camera module 10 may not malfunction due to external electromagnetic waves.

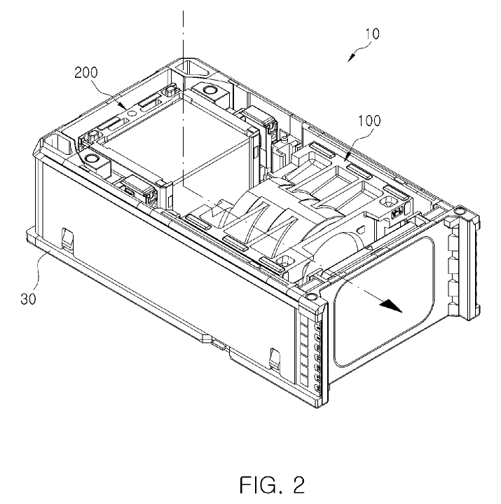

The housing 30 may be configured to accommodate the main components of the camera module 10. For example, a lens module 100 and a prism module 200 may be disposed side by side inside the housing 30 as illustrated in FIG. 2.

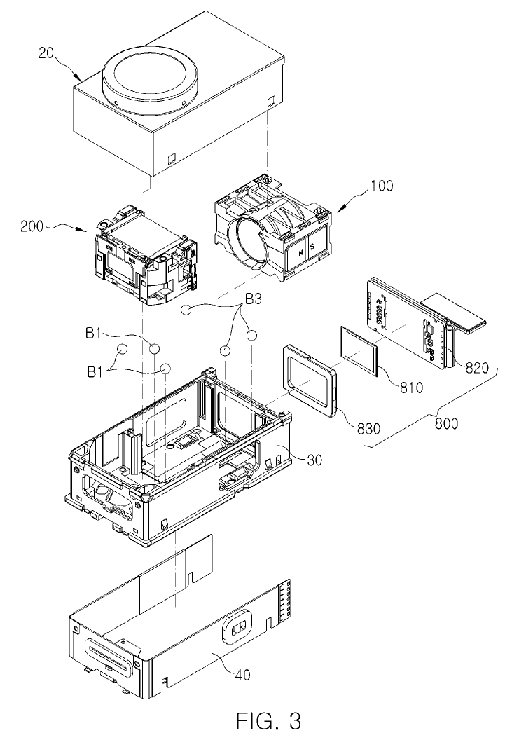

The camera module 10 may further include components for the main operation of the camera module 10 in addition to the lens module 100 and the prism module 200. For example, the camera module 10 may include a substrate 40, an image sensor module 800, and a plurality of ball bearings B1 and B3 as illustrated in FIG. 3.

The substrate 40 may include printed circuits and components necessary for driving the camera module 10. For example, passive components, sensors, coils, or the like, required for driving the lens module 100 and the prism module 200 may be disposed on the substrate 40.

The image sensor module 800 may be configured to convert an optical signal incident through the lens module 100 and the prism module 200 into an electrical signal. The image sensor module 800 may include an image sensor 810, a package substrate 820, and a sensor housing 830. However, the configuration of the image sensor module 800 is not limited to the components described above. For example, the image sensor module 800 may further include a filter member blocking infrared or ultraviolet rays.

Ball bearings B1 and B3 may be configured to enable the lens module 100 and the prism module 200 to move smoothly. For example, the ball bearing B3 may be configured to smoothly perform linear reciprocating motion of the lens module 100, and the ball bearing B1 may be configured to smoothly perform rotational motion of the prism module 200.

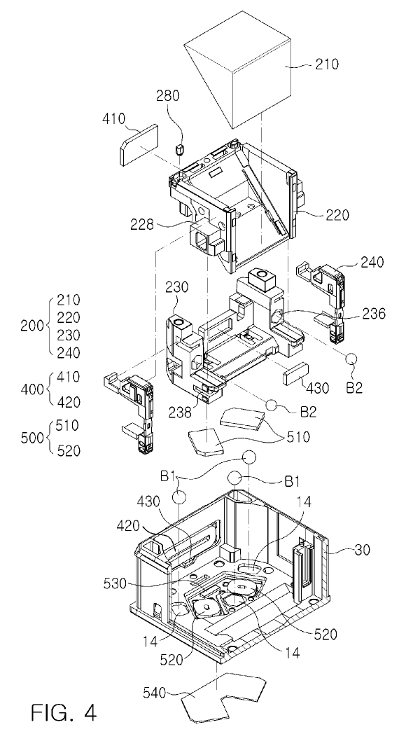

Next, the prism module 200 and a driving structure of the prism module 200 will be described with reference to FIG. 4.

The prism module 200 may be disposed at one end of the housing 30 as illustrated in FIG. 4. However, a position of the prism module 200 is not limited to one end of the housing 30. The prism module 200 may include a prism 210 and a prism holder. To elaborate, the prism module 200 may include a first movable body 220 and a second movable body 230 performing the functions of the prism 210 and the prism holder. Additionally, the prism module 200 may further include a clip member 240. The prism module 200 may be configured to perform an optical image stabilization of the camera module 10. To elaborate, the prism module 200 may be configured to be capable of rotation or driving in a direction, intersecting an optical axis. For example, the prism module 200 may be configured to be capable of rotating or turning in a first direction and a second direction, intersecting the optical axis. To this end, the prism module 200 may include a first driving unit 400 and a second driving unit 500 for driving the prism 210 in a direction, intersecting the optical axis. Additionally, the prism module 200 may include a plurality of magnetic bodies 430 and 530, and a yoke 540 to stably maintain a position of the prism module 200.

The first movable body 220 may be configured to support or accommodate the prism 210. For example, the first movable body 220 may prevent the prism 210 from being detached by contacting a plurality of side surfaces of the prism 210 and may move integrally with the prism 210. The first movable body 220 may be configured to rotate in a first direction, intersecting the optical axis. For example, the first movable body 220 may be rotated in the up and down direction via a ball bearing B2 disposed between a protrusion 228 of the first movable body 220 and a groove 236 of the second movable body 230. The configuration may be formed in the first movable body 220 to suppress direct collision between the prism module 200 and the case 20. For example, a buffer member 280 may be disposed on one side of an upper portion of the first movable body 220 as illustrated in FIG. 4.

The second movable body 230 may be configured to support the first movable body 220. For example, the second movable body 230 may be configured to support a portion of the first movable body 220 via a ball bearing B2. The second movable body 230 may be disposed to be rotatable in the housing 30. For example, the second movable body 230 may be disposed to be rotatable in the housing 30 via a ball bearing B1 disposed between the second movable body 230 and a groove 14 of the housing 30.

The clip member 240 may be configured to couple the first movable body 220 and the second movable body 230. To elaborate, the clip member 240 may be inserted into the protrusion 228 of the first movable body 220 and a groove 238 of the second movable body 230 to maintain a combined state of the first movable body 220 and the second movable body 230. Accordingly, even if the first movable body 220 rotates on the second movable body 230, the combined state of the first movable body 220 and the second movable body 230 may be maintained by the clip member 240.

The first driving unit 400 may be configured to rotate the first movable body 220. In this case, the first driving unit 400 may include a first driving magnet 410 and a first driving coil 420. The first driving magnet 410 may be disposed on a rear surface of the first movable body 220. However, the disposed position of the first driving magnet 410 is not limited to the rear surface of the first movable body 220. The first driving coil 420 may be disposed to face the first driving magnet 410. For example, the first driving coil 420 may be disposed on an inner-side surface of the housing 30, which is opposite to the first driving magnet 410. The first driving unit 400 configured in this manner may rotate the first movable body 220 in a clockwise direction or a counter-clockwise direction through electromotive force generated between the first driving magnet 410 and the first driving coil 420.

The second driving unit 500 may be configured to rotate the second movable body 230. In this case, the second driving unit 500 may include a second driving magnet 510 and a second driving coil 520. The second driving magnet 510 may be disposed on a lower surface of the second movable body 230. However, the placement of the second driving magnet 510 is not limited to the lower surface of the second movable body 230. The second driving coil 520 may be disposed to face the second driving magnet 510. For example, the second driving coil 520 may be disposed on a bottom surface of the housing 30, which is opposite to the second driving magnet 510. The second driving unit 500 configured in this manner may rotate the second movable body 230 clockwise or counterclockwise through electromotive force generated between the second driving magnet 510 and the second driving coil 520.

The magnetic bodies 430 and 530, and the yoke 540 may be configured to reduce arbitrary movements of the first movable body 220 and the second movable body 230. As an example, the magnetic body 430 is disposed to face the first driving magnet 410 on the second movable body 230 to suppress the first movable body 220 from rotating in an unspecified direction when the first driving unit 400 is in an inoperative state. As another example, the magnetic body 530 and the yoke 540 may be disposed to face the second driving magnet 510 in the housing 30 to suppress the second movable body 230 from rotating in an unspecified direction in the inoperative state of the second driving unit 500.

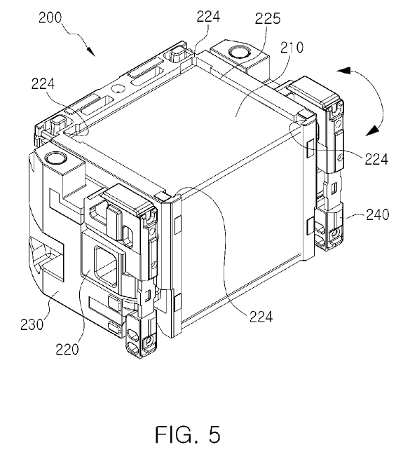

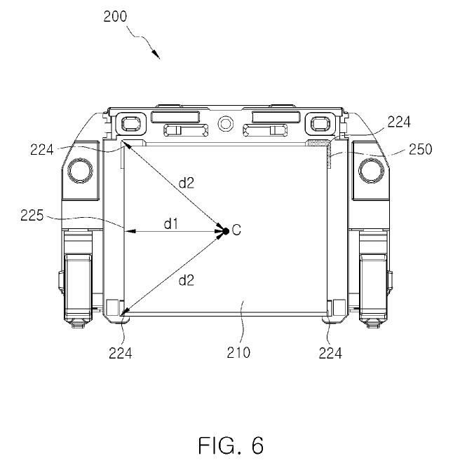

Next, a main configuration of the prism module 200 is described with reference to FIGS. 5 and 6.

The prism module 200 may include the prism 210, the first movable body 220, the second movable body 230, and the clip member 240. The prism 210 may be attached or fixed to the first movable body 220. The prism module 200 according to the present embodiment may be configured to prevent or reduce breakage of the prism 210. For example, a plurality of spaces having different sizes may be disposed between the prism 210 and the first movable body 220. For example, a space being disposed between the prism 210 and the first movable body 220 may refer to the prism 210 being spaced apart from the first movable body 220 by a gap. As a specific example, a first space 225 and a second space 224 may be disposed between an edge of the prism 210 and an inner-side surface of the first movable body 220. The second space 224 is disposed in a region where four corners of the prism 210 and the first movable body 220 face each other, and the first space 225 may be disposed in a region excluding the second space 224. For example, the second space 224 may refer to a second gap where four corners of the prism 210 are spaced apart from and face the first movable body 220, and the first space 225 may refer to a first gap where the prism 210 is spaced apart from the first movable body 220 excluding the second gap.

The first space 225 and the second space 224 may have a predetermined size relationship. As an example, the second space 224 may be wider than the first space 225. As a specific example, the second space 224 may be widely formed so that a corner of the prism 210 may not be contacted to the first movable body 220, and the first space 225 may be narrowly formed so that a side surface of the prism 210 may be contacted to the inner-side surface of the first movable body 220.

The first space 225 and the second space 224 may be disposed at a predetermined distance from an optical axis C of the prism 210. As an example, the first space 225 may be formed in a region having a substantially shortest distance from the optical axis C of the prism 210, and the second space 224 may be formed in a region having a substantially longest distance from the optical axis C of the prism 210. As another example, a distance d2 from the second space 224 to the optical axis C of the prism 210 may be greater than a distance d1 from the first space 225 to the optical axis C of the prism 210.

The first space 225 and the second space 224 disposed as described above enable stable combining and contacting between the prism 210 and the first movable body 220, while reducing or suppressing damage to the prism 210 due to collision between the prism 210 and the first movable body 220.

The prism module 200 according to the present embodiment may further include a configuration for reducing or suppressing breakage of the prism 210. For example, a buffer member 250 may be formed or attached in the second space 224. The buffer member 250 may be formed of a material having a predetermined degree of elasticity. As a specific example, the buffer member 250 may be selected from among materials lightweight and easily elastically deformed, such as rubber, elastomer and the like. For example, the buffer member 250 may be disposed in the second space 224.

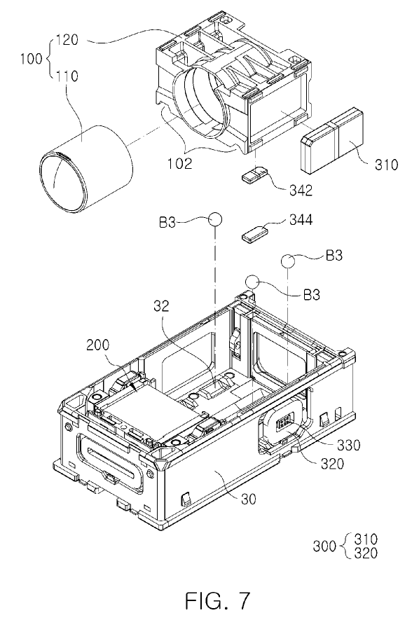

Next, a main configuration of the lens module 100 will be described with reference to FIG. 7.

The lens module 100 may be configured to transmit light incident through the prism module 200 to the image sensor module 800. For example, the lens module 100 may be disposed between the prism module 200 and the image sensor module 800. The lens module 100 may be configured to be movable in the optical axis direction. For example, the lens module 100 may move linearly along one direction of the housing 30 via the driving unit 300.

The lens module 100 may include a lens barrel 110 including one or more lenses and a barrel holder 120. However, the configuration of the lens module 100 is not limited to the lens barrel 110 and the barrel holder 120.

The lens module 100 may be configured to move quickly and smoothly inside the housing 30. For example, the lens module 100 may easily move inside the housing 30 via the ball bearing B3 disposed between a guide groove 32 of the housing 30 and a groove 102 of the lens module 100.

The driving unit 300 may be configured to move the lens module 100 in the optical axis direction. In this case, the driving unit 300 may include a driving magnet 310 and a driving coil 320. The driving magnet 310 may be disposed on one side of the lens module 100. For example, driving magnets 310 may be disposed on both side surfaces of the barrel holder 120. The driving coil 320 may be disposed to generally face the driving magnet 310. For example, driving coils 320 may be disposed on inner-side surfaces of the housing 30.

The camera module 10 may further include a configuration that enables stable drive of the lens module 100. For example, the camera module 10 may further include a Hall sensor 330 and a plurality of magnetic bodies 342 and 344.

The Hall sensor 330 may be disposed at the center of the winding of the driving coil 320. The Hall sensor 330 disposed in this manner may detect the driving position of the lens module 100 and enable quantitative movement of the lens module 100 by the driving unit 300.

The magnetic bodies 342 and 344 may be disposed in the lens module 100 and the housing 30, respectively. For example, the first magnetic body 342 may be disposed on the lower surface of the lens module 100, and the second magnetic body 344 may be disposed on the bottom of the housing 30. The first magnetic body 342 and the second magnetic body 344 may be disposed facing each other. In addition, the first magnetic body 342 and the second magnetic body 344 may be configured with at least one permanent magnet among the first magnetic body 342 and the second magnetic body 344 to generate a strong attractive force therebetween. The first magnetic body 342 and the second magnetic body 344 configured in this manner may suppress the lens module 100 from being separated from the inside of the housing 30 through the attractive force acting on each other. In addition, the first magnetic body 342 and the second magnetic body 344 may maintain a constant distance between the lens module 100 and the housing 30 through the attractive force acting on each other.

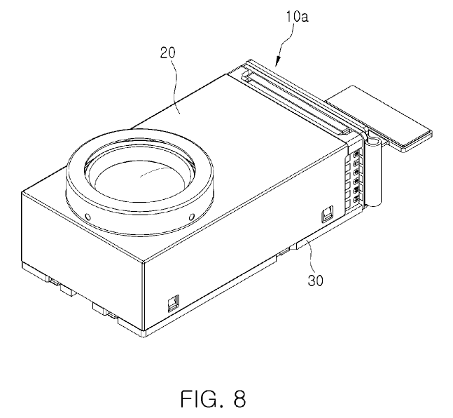

Next, a camera module according to another embodiment will be described with reference to FIGS. 8 to 14.

A camera module 10a according to the present embodiment may include the case 20 and the housing 30 as illustrated in FIGS. 8 to 10. However, a configuration of the camera module 10a is not limited to the case 20 and the housing 30.

The case 20 may be configured to protect the main components of the camera module 10a. For example, the case 20 may be configured to surround the housing 30 so that an open portion and significant portions of the housing 30 are not exposed to outside. The case 20 may be configured to shield electromagnetic waves. For example, the case 20 may be formed of a material blocking or shielding electromagnetic waves so that the main components of the camera module 10a may not malfunction due to external electromagnetic waves.

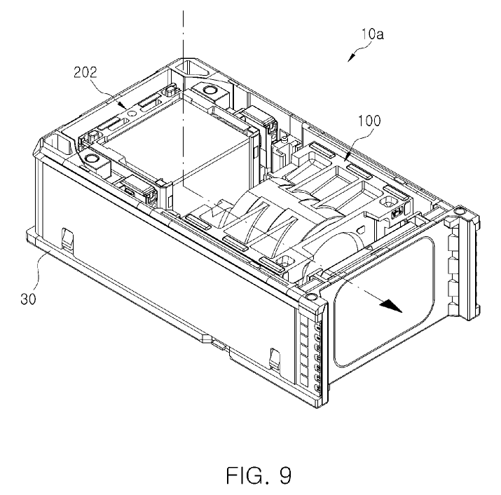

The housing 30 may be configured to accommodate the main components of the camera module 10a. For example, the lens module 100 and a prism module 202 may be disposed side by side inside the housing 30 as illustrated in FIG. 9.

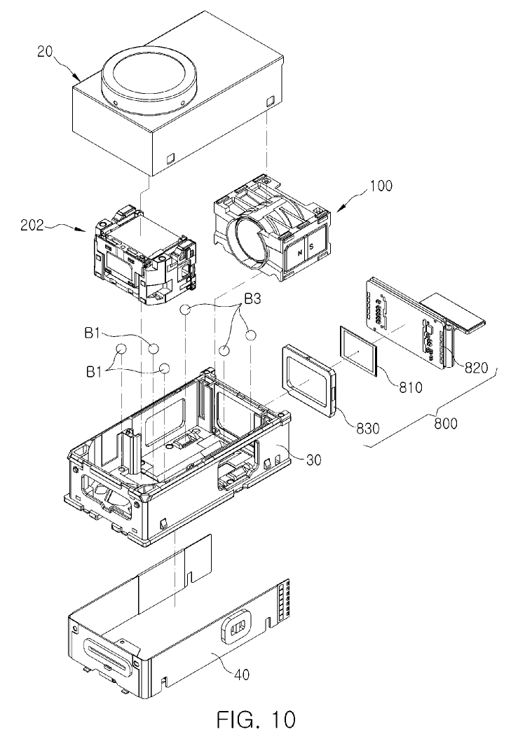

The camera module 10a may further include components for a main operation of the camera module 10a in addition to the lens module 100 and the prism module 202. For example, the camera module 10a may include the substrate 40, the image sensor module 800, and a plurality of ball bearings B1 and B3 as illustrated in FIG. 10.

The substrate 40 may include printed circuits and components necessary for driving the camera module 10a. For example, passive components, sensors, coils, and the like required to drive the lens module 100 and the prism module 202, may be disposed on the substrate 40.

The image sensor module 800 may be configured to convert an optical signal incident through the lens module 100 and the prism module 202 into an electrical signal. The image sensor module 800 may include an image sensor 810, a package substrate 820, and a sensor housing 830. However, the configuration of the image sensor module 800 is not limited to the components described above. For example, the image sensor module 800 may further include a filter member blocking infrared or ultraviolet rays.

The Ball bearings B1 and B3 may be configured to enable smooth operation of the lens module 100 and the prism module 202. For example, the ball bearing B3 may be configured to smoothly perform linear reciprocating motion of the lens module 100, and the ball bearing B1 may be configured to smoothly perform rotational motion of the prism module 202.

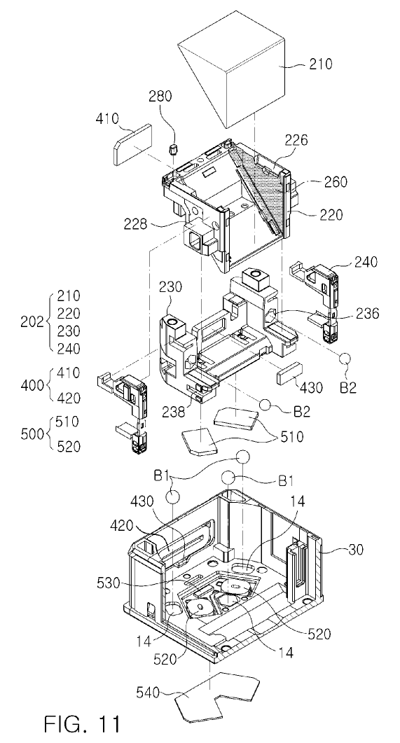

Next, the prism module 202 and a driving structure of the prism module 202 will be described with reference to FIG. 11.

The prism module 202 may be disposed at one end of the housing 30 as illustrated in FIG. 11. However, the placement of the prism module 202 is not limited to one end of the housing 30. The prism module 202 may include the prism 210 and the prism holder. To elaborate, the prism module 202 may include the first movable body 220 and the second movable body 230 performing the functions of the prism 210 and the prism holder. Additionally, the prism module 202 may further include the clip member 240. The prism module 202 may be configured to perform an optical image stabilization of the camera module 10a. To elaborate, the prism module 202 may be configured to be rotatable or driven in a direction, intersecting the optical axis. For example, the prism module 202 may be configured to capable of rotation or rotation in a first direction and a second direction, intersecting the optical axis. In this case, the prism module 202 may include the first driving unit 400 and the second driving unit 500 for driving the prism 210 in a direction, intersecting the optical axis. Additionally, the prism module 202 may include a plurality of magnetic bodies 430 and 530 and the yoke 540 to stably maintain a position of the prism module 202.

The prism module 202 may further include an adhesive member 260 for firmly attaching the prism 210 and the first movable body 220. As an example, the adhesive member 260 may be applied or formed only on an inner-side surface of the first movable body 220 facing a side surface of the prism 210 as illustrated in FIG. 11. However, the applying and forming position of the adhesive material 260 is not limited to a portion illustrated in FIG. 11. For example, the adhesive member 260 may be applied or formed on all portions where the prism 210 and the first movable body 220 may be enabled to contact. As an example, the adhesive member 260 may be disposed only on an inner-side surface of the first movable body 220 facing a side surface of the prism 210. As another example, the adhesive member 260 may be disposed on all portions where the prism 210 and the first movable body 220 may be enabled to contact.

The first movable body 220 may be configured to support or accommodate the prism 210. For example, the first movable body 220 may prevent the prism 210 from being detached by contacting a plurality of side surfaces of the prism 210 and may move integrally with the prism 210. The first movable body 220 may be configured to rotate in a first direction, intersecting the optical axis. For example, the first movable body 220 may be rotated in the up and down direction via a ball bearing B2 disposed between a protrusion 228 of the first movable body 220 and a groove 236 of the second movable body 230. A configuration may be formed in the first movable body 220 to suppress direct collision between the prism module 202 and the case 20. For example, the buffer member 280 may be formed on one side of an upper portion of the first movable body 220 as illustrated in FIG. 11. For example, the buffer member 280 may be disposed on one side of an upper portion of the first movable body 220 as illustrated.

The second movable body 230 may be configured to support the first movable body 220. For example, the second movable body 230 may be configured to support a portion of the first movable body 220 via a ball bearing B2. The second movable body 230 may be disposed to be rotatable in the housing 30. For example, the second movable body 230 may be disposed to be rotatable in the housing 30 via a ball bearing B1 disposed between the second movable body 230 and a groove 14 of the housing 30.

The clip member 240 may be configured to combine the first movable body 220 and the second movable body 230. To elaborate, the clip member 240 may be inserted onto the protrusion 228 of the first movable body 220 and into a groove 238 of the second movable body 230 to maintain a combined state of the first movable body 220 and the second movable body 230. Accordingly, even if the first movable body 220 rotates on the second movable body 230, the combined state of the first movable body 220 and the second movable body 230 may be maintained by the clip member 240.

The first driving unit 400 may be configured to rotate the first movable body 220. In this case, the first driving unit 400 may include a first driving magnet 410 and a first driving coil 420. The first driving magnet 410 may be disposed on a rear surface of the first movable body 220. However, the disposed position of the first driving magnet 410 is not limited to the rear surface of the first movable body 220. The first driving coil 420 may be disposed to face the first driving magnet 410. For example, the first driving coil 420 may be disposed on an inner-side surface of the housing 30, which is opposite to the first driving magnet 410. The first driving unit 400 configured in this manner may rotate the first movable body 220 downward or upward through electromotive force generated between the first driving magnet 410 and the first driving coil 420.

The second driving unit 500 may be configured to rotate the second movable body 230. In this case, the second driving unit 500 may include a second driving magnet 510 and a second driving coil 520. The second driving magnet 510 may be disposed on a lower surface of the second movable body 230. However, the placement of the second driving magnet 510 is not limited to the lower surface of the second movable body 230. The second driving coil 520 may be disposed to face the second driving magnet 510. For example, the second driving coil 520 may be disposed on a bottom surface of the housing 30, which is opposite to the second driving magnet 510. The second driving unit 500 configured in this manner may rotate the second movable body 230 clockwise or counterclockwise through electromotive force generated between the second driving magnet 510 and the second driving coil 520.

The magnetic bodies 430 and 530, and the yoke 540 may be configured to reduce arbitrary movements of the first movable body 220 and the second movable body 230. As an example, the magnetic body 430 is disposed to face the first driving magnet 410 on the second movable body 230 to suppress the first movable body 220 from rotating in an unspecified direction when the first driving unit 400 is in an inoperative state. As another example, the magnetic body 530 and the yoke 540 may be disposed to face the second driving magnet 510 in the housing 30 to suppress the second movable body 230 from rotating in an unspecified direction in the inoperative state of the second driving unit 500.

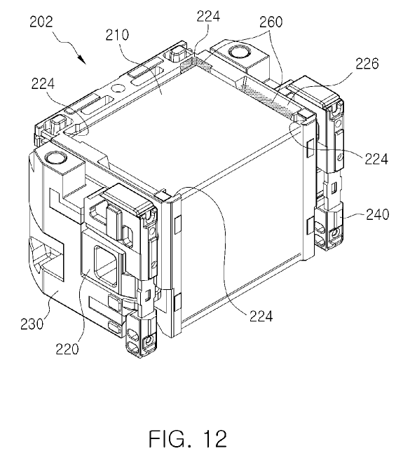

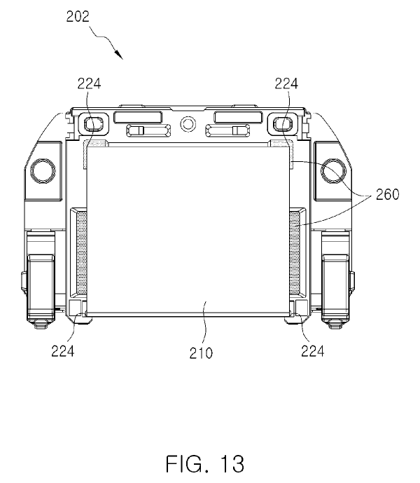

Next, a main configuration of a prism module 202 will be described with reference to FIGS. 12 and 13.

The prism module 202 may include the prism 210, the first movable body 220, the second movable body 230, the clip member 240, and the adhesive member 260. The prism 210 may be attached or fixed to the first movable body 220 by the adhesive member 260. The adhesive member 260 may be applied or formed (disposed) on at least one surface where the prism 210 and the first movable body 220 face each other. A recess portion (second space) 224 may be formed in the first movable body 220 to reduce or suppress damage to the prism 210. To elaborate, the recess portion 224 having a generally predetermined size may be formed in a region facing a corner of a prism 210 in the first movable body 220 (for example, a corner of an incident surface of the prism 210), as illustrated in FIGS. 12 and 13. The recess portion 224 is formed not to contact with the corner of the prism 210, thereby reducing and suppressing the breakage of the prism 210 due to contact or collision between the prism 210 and the first movable body 220.

The first movable body 220 according to the present embodiment may be configured to prevent contamination of the prism 210 by the adhesive member 260. As an example, a receiving portion 226 for receiving the adhesive member 260 may be formed in a portion of a region facing an edge of the prism 210 in the first movable body 220 as illustrated in FIGS. 12 and 13. The receiving portion 226 may be configured to receive a significant amount of adhesive member 260 to suppress or block a phenomenon in which the adhesive material 260 applied between the prism 210 and the first movable body 220 overflows onto one surface of the prism 210. In addition, the recess portion 224 of the first movable body 220 may also be configured to receive the adhesive member 260 and, like the receiving portion 226, may suppress or block the phenomenon of the adhesive member 260 overflowing onto one surface of the prism 210. Meanwhile, the adhesive member 260 accommodated in the recess portion 224 may block direct contact between the prism 210 and the first movable body 220, thereby reducing damage applied to a corner portion of the prism 210.

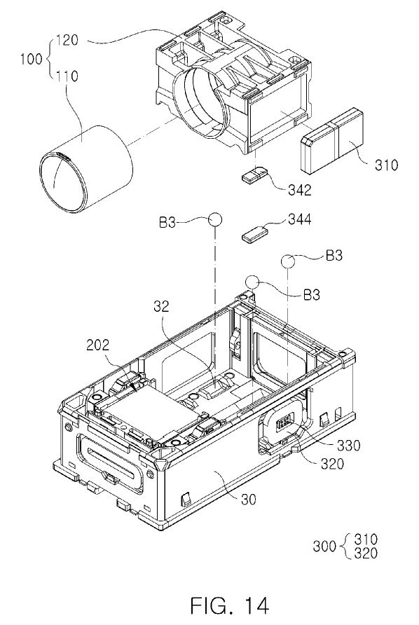

Next, a main configuration of the lens module 100 will be described with reference to FIG. 14.

The lens module 100 may be configured to transmit light incident through the prism module 202 to the image sensor module 800. For example, the lens module 100 may be disposed between the prism module 202 and the image sensor module 800. The lens module 100 may be configured to be movable in the optical axis direction. For example, the lens module 100 may move linearly along one direction of the housing 30 via the driving unit 300.

The lens module 100 may include a lens barrel 110 including one or more lenses and a barrel holder 120. However, the configuration of the lens module 100 is not limited to the lens barrel 110 and the barrel holder 120.

The lens module 100 may be configured to move quickly and smoothly inside the housing 30. For example, the lens module 100 may easily move inside the housing 30 via the ball bearing B3 disposed between a guide groove 32 of the housing 30 and a groove 102 of the lens module 100.

The driving unit 300 may be configured to move the lens module 100 in the optical axis direction. In this case, the driving unit 300 may include a driving magnet 310 and a driving coil 320. The driving magnet 310 may be disposed on one side of the lens module 100. For example, driving magnets 310 may be disposed on both side surfaces of the barrel holder 120. The driving coil 320 may be disposed to generally face the driving magnet 310. For example, driving coils 320 may be disposed on inner-side surfaces of the housing 30.

The camera module 10a may further include a configuration that enables stable drive of the lens module 100. For example, the camera module 10 may further include the Hall sensor 330 and the plurality of magnetic bodies 342 and 344.

The Hall sensor 330 may be disposed at the center of the winding of the driving coil 320. The Hall sensor 330 disposed in this manner may detect the driving position of the lens module 100 and enable quantitative movement of the lens module 100 by the driving unit 300.

The magnetic bodies 342 and 344 may be disposed in the lens module 100 and the housing 30, respectively. For example, the first magnetic body 342 may be disposed on the lower surface of the lens module 100, and the second magnetic body 344 may be disposed on the bottom of the housing 30. The first magnetic body 342 and the second magnetic body 344 may be disposed facing each other. In addition, the first magnetic body 342 and the second magnetic body 344 may be configured with at least one permanent magnet among the first magnetic body 342 and the second magnetic body 344 to generate a strong attractive force therebetween. The first magnetic body 342 and the second magnetic body 344 configured in this manner may suppress the lens module 100 from being separated from the inside of the housing 30 through the attractive force acting on each other. In addition, the first magnetic body 342 and the second magnetic body 344 may maintain a constant distance between the lens module 100 and the housing 30 through the attractive force acting on each other.

The camera module according to the present disclosure may reduce a phenomenon of prism breakage due to internal collision or other external impact.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a prism module including a prism configured to reflect light incident along a first optical axis in a second optical axis direction and a prism holder configured to support the prism; and
a lens module configured to focus light emitted from the prism onto an image sensor,
wherein a first space and a second space having different sizes are disposed between an edge of the prism and an inner-side surface of the prism holder.

2. The camera module of claim 1, further comprising a first driving unit configured to drive the prism holder.

3. The camera module of claim 1, further comprising a second driving unit configured to drive the lens module.

4. The camera module of claim 1, wherein a distance from the first space to an optical axis of the prism is less than a distance from the second space to the optical axis of the prism.

5. The camera module of claim 1, further comprising a buffer member disposed on the prism holder and protruding in the first optical axis direction.

6. The camera module of claim 1, wherein the prism holder comprises:
a first movable body configured to accommodate the prism;
a second movable body configured to be coupled with the first movable body; and
a ball bearing disposed between the first movable body and the second movable body to enable rotational movement of the first movable body with respect to the second movable body.

7. The camera module of claim 6, further comprising a clip member coupled with the second movable body and configured to prevent the first movable body from being separated from the second movable body.

8. The camera module of claim 6, further comprising a first driving unit configured to provide driving force for driving the first movable body.

9. The camera module of claim 6, further comprising a first driving unit configured to rotate the second movable body around the first optical axis.

10. A camera module comprising:
a prism and a prism holder configured to support the prism,
wherein the prism holder comprises a recess portion configured to accommodate a portion of an adhesive member disposed between a side surface of the prism and the prism holder.

11. The camera module of claim 10, wherein the recess portion is disposed at a portion facing a corner of an incident surface of the prism.

12. The camera module of claim 10, further comprising a first driving unit configured to drive the prism holder.

13. The camera module of claim 10, further comprising a buffer member disposed on the prism holder and protruded in one direction.

14. The camera module of claim 10, wherein the prism holder comprises:
a first movable body configured to accommodate the prism;
a second movable body configured to be coupled with the first movable body; and
a ball bearing disposed between the first movable body and the second movable body to enable rotational movement of the first movable body with respect to the second movable body.

15. The camera module of claim 14, further comprising a clip member coupled with the second movable body and configured to prevent the first movable body from being separated from the second movable body.

16. The camera module of claim 14, further comprising a plurality of driving units configured to drive the first movable body and the second movable body in different directions.
